(19) United States
(12) Patent Application Publication
(10) Pub. No.: US 2025/0033210 A1
(43) Pub. Date: Jan. 30, 2025

(54) SYSTEM, METHOD, AND DEVICE FOR DUST TOLERANT ROBOTIC INTERFACE

(71) Applicant: MacDonald, Dettwiler and Associates Inc., Brampton (CA)

(72) Inventors: Heather Ker, Guelph (CA); Sean Jessen, Brampton (CA); Valeri Kirischian, North York (CA)

(21) Appl. No.: 18/717,259

(22) PCT Filed: Dec. 20, 2022
(86) PCT No.: PCT/CA2022/051868

§ 371 Date: Jun. 6, 2024

Related U.S. Application Data
(60) Provisional application No. 63/291,603, filed on Dec. 20, 2021.

(51) Int. Cl. B25J 9/16

(52) U.S. Cl. CPC B25J 9/1664

(57) ABSTRACT

Dust tolerant robotic interfaces and systems, methods, and devices for a dust tolerant robotic interface are provided. A dust tolerant electromechanical interface includes a parent module and a child module. The parent module includes a parent mating surface, a mechanical alignment feature, a rigidizing module, and an auxiliary services module. The child module includes a child mating surface, a mechanical alignment target, a rigidizing target, and an auxiliary services reception module. The interface includes unmated and mated and rigidized configurations. In the mated and rigidized configuration, the parent mating surface and child mating surface are substantially parallel and within a separation distance, the mechanical alignment feature engages the mechanical alignment target, the rigidizing module engages the rigidizing target, the auxiliary services reception module engages the auxiliary services reception module, and the rigidizing module is enabled, fixing the parent module to the child module. Auxiliary services may include any one or more of electrical power, mechanical torque, and data.

### TECHNICAL FIELD

The following relates generally to robotic interfaces, and more particularly to systems and methods for dust tolerant robotic interfaces.

### INTRODUCTION

Components of robotic systems may advantageously be attached and detached from one another. The system may be deemed an interface, to transfer energy (of any form), fluids or gases, and/or data between detachable components.

Robotic systems may be used in dusty environments, for example, the lunar surface. Current robotic system interfaces make use of conductive electrical contacts for both data and electrical power transfer across the interface. Dust can adhere to surfaces and foul mating interfaces, reducing the efficiency, and reliability, of electrical power and data transfer across the interface. Additionally, robotic systems may utilize physically interacting mechanisms to align/mate/rigidize components to form interfaces, as well as to mechanically transfer energy. Such physically interacting mechanisms may be prone to failure in dusty environments, as dust may adhere to surfaces and physically interfere with alignment and mating mechanisms.

Additionally, when operated in dusty environments, robotic interfaces may face risks of jamming. For example, when a robotic interface is mated, and dust is present on mating surfaces, dust may foul mating surfaces and mechanisms, preventing the interface from physically un-mating, jamming the interface and rendering the interface inoperable.

In interfaces wherein many physical components are required to engage, dust, which may have abrasive characteristics, may abrade surfaces, resulting in premature wear, reducing the useful lifespan of the interface.

Accordingly, there is a need for an improved system and method for a dust tolerant robotic interface that overcomes at least some of the disadvantages of existing robotic interfaces.

### SUMMARY

Other aspects and features will become apparent, to those ordinarily skilled in the art, upon review of the following description of some exemplary embodiments.

Described herein is a dust tolerant electromechanical interface including a parent module and a child module. The parent module includes a parent mating surface, a mechanical alignment feature, a rigidizing module, and an auxiliary services module.

The child module comprises a child mating surface, a mechanical alignment target, a rigidizing target, and an auxiliary services reception module.

The interface includes an unmated configuration and a mated and rigidized configuration, wherein when the interface is in the mated and rigidized configuration, the parent mating surface and child mating surface are substantially parallel and within a separation distance, the separation distance corresponding to a distance separating the parent mating surface and child mating surface within which the rigidizing module of the parent module is operative to fix the parent module to the child module, the mechanical alignment feature engages the mechanical alignment target, the rigidizing module engages the rigidizing target, the auxiliary services module engages the auxiliary services reception module such that auxiliary services can be passed to the child module and the rigidizing module is enabled, fixing the parent module to the child module.

In some examples, the auxiliary services module comprises an electrical power transfer module, and the auxiliary services reception module comprises an electrical power reception module.

In some examples, the auxiliary services module comprises a parent communication module, and the auxiliary services reception module comprises a child communication module.

In some examples, the auxiliary services module comprises a parent fluid transfer module and the auxiliary services reception module comprises a child fluid reception module.

In some examples, the rigidizing module comprises a controllable magnet, and the rigidizing target comprises a ferromagnetic body, wherein when the interface is in the mated and rigidized configuration, the controllable magnet may be activated, such that magnetic force fixes the parent module to the child module.

In some examples, the electrical power transfer module and the electrical power reception module are inductively coupled, such that when the electrical power transfer module and the electrical power reception module are within a transferring distance, the electrical power transfer module induces a voltage within the electrical power reception module, transferring power from the electrical power transfer module to the electrical power reception module.

In some examples, when the interface is in the mated and rigidized configuration, the electrical power transfer module and the electrical power reception module are within the transferring distance.

In some examples, the electrical power transfer module transfers power to the electrical power reception module of at least 70 W continuously.

In some examples, the electrical power transfer module and the electrical power reception module are conductively coupled, such that the electrical power transfer module conducts electrical power to the electrical power reception module.

In some examples, the parent communication module comprises a radio frequency (“RF”) transmitter and receiver, and the child communication module comprises an RF transmitter and receiver, wherein when the interface is in the mated and rigidized configuration, the parent communication module sends and receives an RF signal to and from the child communication module.

In some examples, the communication modules transfer data at a rate of at least 3 Gbps.

In some examples, the mechanical alignment feature comprises a plurality of dust tolerant alignment pins, and the mechanical alignment target comprises a plurality of dust tolerant apertures which are configured such that the dust tolerant apertures receive the dust tolerant alignment pins.

In some examples, the auxiliary services module comprises a torque transfer mechanism and the auxiliary services reception module further comprises a torque receiving mechanism, and wherein when the interface is in the mated and rigidized configuration, the torque transfer mechanism engages the torque receiving mechanism, such that the torque transfer mechanism rotates the torque receiving mechanism.

In some examples, the rigidizing module comprises a controllable magnet, and the rigidizing target comprises a ferromagnetic body, wherein when the interface is in the mated and rigidized configuration, the controllable magnet is activated, such that magnetic force fixes the parent module to the child module.

Also described herein is a method of aligning, mating and rigidizing the robotic interface. The method includes providing a parent module and a child module, wherein the parent module and child module are in the unmated configuration, aligning the mechanical alignment feature with the mechanical alignment target, decreasing the distance between the parent module and child module, until the mechanical alignment feature engages mechanical alignment target, decreasing the distance between the parent module and child module further, such that the mechanical alignment feature and mechanical alignment target bias the parent module and child module into a position such that child mating surface and parent mating surface are substantially parallel, and enabling the rigidizing module, fixing the parent module to the child module.

Also described herein is a dust tolerant robotic system. The system includes a vehicle, structure or platform, a robotic arm having a proximal end and a distal end, the robotic arm coupled to the vehicle at its proximal end, a first parent module coupled to the distal end of the robotic arm, and a first child module, the child module configured to be reversibly mated and rigidized with the parent module coupled to the distal end of the robotic arm, forming a first interface in the mated and rigidized configuration.

In some examples, the system further comprises a second parent module, wherein the second parent portion is fixed to the first child module, and a tool is fixed to the first child module or the second parent module.

In some examples, the system further comprises a second child module fixed to a surface of the platform, wherein the second parent module is configured to be reversibly mated and rigidized to the second child module, forming a second interface in the mated and rigidized configuration, and wherein the first interface is configured to be in an unmated configuration while the second interface is in a mated and rigidized configuration, such that the tool is coupled to the vehicle through the second parent module or first child module, and not the robotic arm.

In some examples, the auxiliary services module of the first parent module comprises a torque transfer mechanism and the auxiliary services module of the first child module further comprises a torque receiving mechanism, and wherein when the first interface is in the mated configuration, the torque transfer mechanism engages with the torque receiving mechanism, such that the torque transfer mechanism rotates the torque receiving mechanism.

In some examples, the torque receiving mechanism provides rotational force or linear force to the tool.

In some examples, the torque transfer mechanism of the first parent module transfers torque through the torque receiving mechanism of the first child module to a torque transfer mechanism of the second parent module, and wherein the torque received at the torque transfer mechanism of the second parent module is used to actuate the rigidizing module of the second parent module.

### BRIEF DESCRIPTION OF THE DRAWINGS

The drawings included herewith are for illustrating various examples of articles, methods, and apparatuses of the present specification. In the drawings:

FIG. 1 is a block diagram of a dust tolerant robotic interface in an unmated configuration, according to an embodiment;

FIG. 2 is a block diagram of the dust tolerant robotic interface of FIG. 1, in a mated configuration;

FIG. 3 is a flowchart of a method of mating the robotic interface of FIGS. 1-2, according to an embodiment;

FIG. 4 is a flowchart of a method of un-mating the robotic interface of FIGS. 1-2, according to an embodiment;

FIG. 5 is a block diagram of a dust tolerant robotic system, according to an embodiment;

FIG. 6 is a block diagram of the dust tolerant robotic system of FIG. 5, depicted with additional components;

FIG. 7 is a flowchart of a method of operating the robotic system of FIGS. 5-6, according to an embodiment;

FIG. 8A is a bottom perspective view of a parent module of a dust tolerant robotic interface, according to an embodiment;

FIG. 8B is a top perspective view of the parent module of the dust tolerant robotic interface of FIG. 8A with a portion of outer housing removed to show internal components;

FIG. 9 is a perspective view of a child module of the dust tolerant robotic interface of FIGS. 8A, 8B, according to an embodiment;

FIG. 10 is a schematic diagram of a dust tolerant robotic system in operation, according to an embodiment;

FIG. 11 is a flowchart of a method of operating the robotic system of FIG. 10, according to an embodiment;

FIG. 12 is an internal detail view of the parent module of FIGS. 1-2 including an actively actuated rigidizing module, according to an embodiment;

FIG. 13 is an internal detail view of the parent module of FIGS. 1-2 including a passively actuated rigidizing module, according to another embodiment; and

FIG. 14 is a block diagram of a dust tolerant robotic system including a plurality of dust tolerant robotic interfaces, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to an electromechanical interface, and more particularly to a dust tolerant robotic interface and a system and method to employ the dust tolerant robotic interface in the robotic handling of Orbital Replaceable Units (ORUs) and tools from fixed and mobile platforms.

The dust tolerant robotic interface of the present disclosure comprises a plurality of modules which allow for a robotic system to readily attach and detach components. The dust tolerant robotic interface may include two halves. The dust tolerant robotic interface is configured such that any one or more of data, electrical power, and torque may be transferred through the interface, across each half, and may be operated in dusty environments, such that dust is unlikely to interfere with the structural integrity of the interface, the transfer of electrical power, data or mechanical torque across the interface, or long term reliability of the interface.

Dust tolerant interface, within the context of the invention described herein, refers to an interface which is configured such that the presence of dust within its operating environment may minimally impede the short or long term functionality of the interface. The dust tolerant interface may also be applied in dust-free environments. This feature may provide the advantage of providing a single robotic interface that has dust tolerant properties, and thus can be used in the presence or absence of dust, such as where a robotic interface moves from a dusty to a non-dusty environment or where the robotic interface is used in an environment that is intermittently exposed to dust.

In one embodiment, a dust tolerant robotic interface includes a parent module comprising a robotic end effector wherein the end effector may be connected to various tools. The end effector may be referred to as the parent module in some embodiments.

It may be advantageous for robotic systems to comprise removable components, such as replaceable tools, to simplify system design, increase system longevity and to enable a wider variety of functionality, such as system growth and development. Removable tools may also improve system availability. Worn out tools may be discarded and replaced. Removable tools may reduce the overall duty cycle of core robotic components.

Removable components may be particularly advantageous in environments, such as space, where access to such components is limited. For example, a first tool may be attached to a robotic vehicle, platform or structure to complete a first operation, and then detached from the first tool and attached to the second tool to complete a second operation. Through the operation of subcomponents of the interface, the interface may be rigidized, such that each half of the interface is fixed to one another with sufficient force, such that any tools or other components fixed through the interface may sustain significant rotational, lateral and axial loads without the failure or compromise of performance of the interface. Such fixing force may be mechanical, magnetic (e.g. relying purely on magnetism to resist loads), or some other type of force, or some combination of the foregoing forces.

As used herein, the term “end effector” refers generally to a robotic device or element at the end of a robotic arm, or other positioning device, that performs a function. The term “end effector” as used herein includes devices that are non-separably (i.e. permanently) mounted to the end of the robotic arm, and devices that are separable from the end of the robotic arm. A separable interface may allow the end effector to be picked up, used, and put down (i.e. separated from the robotic arm). Instances of the end effector having a separable interface may also be referred to as a “tool” or “end of arm tool”. In such an instance, the robotic arm may have a first end effector non-separably mounted to its end, which has the function of a tool-changer that allows the robotic arm to use multiple different tools, and a second end effector having the separable interface and which can be engaged by the first end effector and function as a tool. In such a case, the first “tool-changer” end effector and the second “tool” end effector are each considered an end effector. Accordingly, any references to “end effector” herein are intended to include all devices as described in the foregoing unless otherwise noted.

Within the context of the present disclosure, the parent/child terminology is used to distinguish between two halves of the robotic interface that are differently configured. Generally, the parent module is an active half and the child module is a passive half. The “active half” as previously mentioned, refers to the fact that the parent module is the module driving the rigidization and auxiliary services provision, in most examples. In some examples, the child module may actively provision some services to the parent module, such as in examples wherein the interface may allow for two-way data communication between the parent module and child module.

Within the context of the present disclosure, “engage” is defined to include non-mechanical engagement. For example, “engage” may include the interaction of two components through the passing of electromagnetic radiation (EMR), such as for the transmission of electricity or electronic communications through EMR. In this sense, “engage” may be considered to include mechanical interaction, such as through physical contact, and non-mechanical interaction, which may include components coming into operation without physical contact such as described above.

Within the context of the present disclosure, “rigid” and/or “rigidized” is defined as the state wherein the interface has been mechanically aligned and the rigidizing module(s) have been activated, resulting in an interface which cannot be separated along a certain axis or axes without the application of a significant force (e.g. a separation force).

Within the context of the present disclosure, “soft-docking” is defined as the state or condition wherein the interface has been placed into the mechanical position wherein the interface is in mechanical alignment, and within a mating distance, but rigidizing modules have not been activated, and thus, the interface may be separated with a mechanical force along a certain axis or axes (e.g. a force less than the separation force). An interface may be soft-docked without being rigidized; however, the interface cannot be rigidized without being soft-docked.

Within the context of the present disclosure, “mate” or “mated” is defined as the condition wherein the interface has been placed into the mechanical position wherein the interface is in mechanical alignment, and within a mating distance, but rigidizing modules have not been activated, and thus, the interface may be separated with a small or threshold mechanical force along a certain axis or axes. “Mated” may be defied as a synonym of “soft-docking” as defined above. An interface may be mated without being rigidized; however, the interface cannot be rigidized without being mated.

Within the context of the present disclosure, “unmated” is defined as the condition wherein the interface is separated, such that the two portions of the interface are not mechanically engaged and are separated by a relatively large distance (e.g. much larger than the mating distance, such as two or three times the mating distance). According to some embodiments, an interface may not be rigidized if it is unmated.

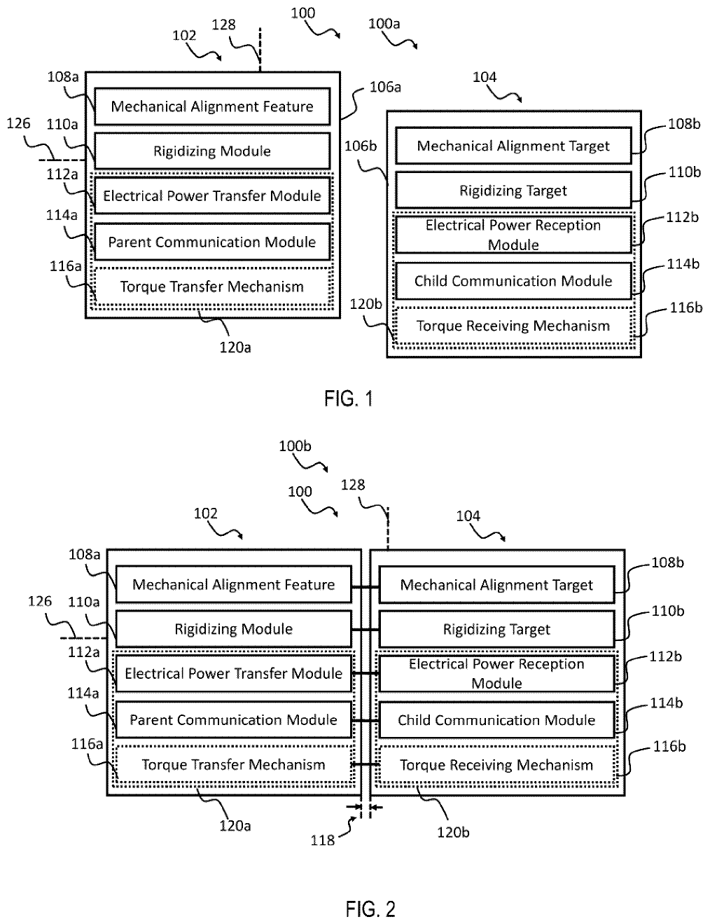

Referring now to FIG. 1, shown therein is a block diagram outlining components of an embodiment of a robotic interface 100 in an unmated configuration 100a. FIG. 2 shows robotic interface 100 in a mated configuration 100b. The interface 100 includes a parent module 102 and a child module 104. In the mated configuration 100b, the parent module 102 and child module 104 are in a desired mechanical position relative to one another, but may not necessarily held together with significant force across all mechanical axes. In the unmated configuration 100a, the parent module 102 and child module 104 may be separated by a distance and may be further unaligned.

Parent module 102 includes a parent mating surface 106a. In the interface 100 of FIGS. 1-2, the parent mating surface 106a comprises a planar surface. The planar surface may be mated with, or butted against or near, another planar surface. In other embodiments, parent mating surface 106a may comprise other shapes and configurations. Parent mating surface 106a may have a complementary shape or profile to any other component to which the parent mating surface 106a is mated.

Parent module 102 may be comprised of aluminum, or other high strength materials. Parent module 102 is configured such that the external structure is dust sealed, wherein dust present in the environment in which the parent module 102 is being utilized may not enter the internal structure of parent module 102. Components of parent module 102 may be joined together with conformable seals. The use of conformal seals may ensure that no small gaps between components are present, reducing the risk of dust ingress. In some examples of parent module 102, parent module 102 may be configured such that parent module is at least IP6X dust tolerant, as per International Electrotechnical Commission (IEC) standard 60529.

Parent module 102 further includes a mechanical alignment feature 108a, a rigidizing module 110a, and an auxiliary services module 120a. The auxiliary services module 120a provides one or more auxiliary services to child module 104. The auxiliary services module 120a may comprise an electrical power transfer module 112a, a parent communication module 114b and a torque transfer mechanism 116a.

Mechanical alignment feature 108a is configured to engage a feature present on the child module 104 when the interface 100 is in the mated configuration 100b. The mechanical alignment feature 108a includes at least one dust tolerant alignment pin. In some embodiments, the dust tolerant alignment pin may include a fine alignment feature and a coarse alignment feature. In some example embodiments, the alignment pin may comprise a fine alignment feature that is generally conical and a coarse alignment feature that is generally cylindrical and of a diameter much smaller than most of the cone of the fine alignment feature. The coarse alignment feature may project out of the cone of the fine alignment feature, such that a longitudinal axis of each of the coarse alignment feature and fine alignment feature are generally collinear. In some example embodiments, the interface 100 may comprise a plurality of mechanical alignment features 108a. Preferably, the interface 100 comprises at least two mechanical alignment features 108a. In a particular embodiment, the interface 100 may include three mechanical alignment features 108a.

Some embodiments of the interface described herein may not include mechanical alignment features and may instead rely upon rigidization subsystems, such as described herein, to maintain general interface alignment.

The rigidizing module 110a is configured to rigidize the interface 100 between the parent module 102 and the child module 104 when in the mated configuration 100b, to place the interface 100 into the rigidized configuration. Rigidizing module 110a is configured such that when interface 100 is in the mated configuration 100b, and rigidizing module 110a is in a rigid and/or enabled configuration, the parent module 102 and child module 104 are in a rigidized configuration and cannot be separated in an axial direction 126 without the application of a significant external force (“separation force”).

In some examples, the separation force may be a minimum of 50 N. In other examples, use case of the interface may affect required minimum separation force. For example, the separation force above may be defined in an example wherein mating distance 118 is 1 mm, and there exists a substantial amount of foreign matter within the mating distance 118. In examples wherein the presence of foreign mater results in a larger mating distance 118, the separation force may be much less. In general, in examples wherein parent module 102 and child module 104 are rigidized through magnetic attraction force, the separation force may scale proportionally to magnetic force at a given mating distance 118.

While the separation force above is described in reference to an axial force, other forces may be of greater interest in some use cases. For example, bending separation force may be of greater interest in a certain use case of interface 100. Bending separation force may be a function of both the axial bending force and the geometry of each module of the interface, as well as the geometry of any present mechanical alignment features. Accordingly, such features of the interface 100 may be designed and configured to adequately resist such bending and rotational loads.

Additionally, rigidizing module 110a may be used to generate a required interface preload, to reduce mechanical load on mechanical alignment mechanism 108a during soft-docking. Rigidizing with respect to the interface 100 implies magnets (or other methods) are used to enact a preload at the interface.

In some examples, rigidizing module 110a comprises a controllable magnet. Rigidizing module 110a is configured such that the controllable magnet may magnetically engage with a feature of child module 104, such that parent module 102 is generally fixed to child module 104. Controllable magnet may be an electrically controllable magnet or mechanically actuated magnet. In an embodiment, mechanical actuation of the mechanically actuated magnet may be controlled by rotary input or other mechanical input. Rotary input may be a motor. There are various types of mechanically actuated magnets, which require different types of inputs (e.g. rotational, linear).

Rigidizing module 110a may comprise an electromagnet. When a current is applied to the electromagnet, the electromagnet generates a magnetic field, which may attract ferromagnetic materials. Electromagnets may require continuous current to either keep the electromagnet on or off. Electromagnets may function similarly to a solenoid.

In some cases, the rigidizing module 110a may comprise an electrically controllable permanent magnet. The magnet may be activated or deactivated with the application of electric pulses and/or other electrical signals, including digital signals and/or analogue signals.

In an embodiment, the electrically controllable permanent magnet may be mechanically actuated. For example, the magnet may be actuated from a first position to a second position, activating the magnet. In an embodiment, this may include mechanically rotating the magnet 180 degrees. In another embodiment, this may include extending and retracting the magnet, which may include axially translating the magnet towards the mating surface 106a (extending) and away from the mating surface 106a (retracting).

In an embodiment, the electrically controllable permanent magnet may comprise an electropermanent magnet, wherein little or no continuous energy input is required to maintain the magnetic force of the electropermanent magnet once activated.

In an embodiment, the controllable magnet may comprise any other system or device which may allow for a magnetic field to be activated or deactivated in response to a mechanical and/or electrical activation and/or control signal.

In some examples, rigidizing module 110a may comprise two separate components, an actuator and a magnet. The actuator is configured to move the magnet from the first position (inactive, non-rigidizing position) to the second position (active, rigidizing position). The actuator may be configured to passively actuate the magnet or actively actuate the magnet. In the case of passive actuation, the drive force for driving the actuator is supplied from a drive system external to the parent module 102 and received across the interface 100 (e.g., received and supplied to the actuator by torque transfer mechanism 116a). In the case of active actuation, the drive force for driving the actuator is supplied by a drive system internal to the parent module 102, such as a motor. In an embodiment, the actuator may comprise a redundant DC brushless servo motor, acting through a gear train, with a non-backdrivable power screw. The actuator may be equipped with a motor resolver for position sensing. The position sensing may be used to sense when the magnet is in the first position and second position. A set of redundant position sensors, such as microswitches or reed switches may provide absolute position feedback.

In some examples, a permanent magnet may be mechanically rotated 180 degrees by the actuator to activate or deactivate the rigidizing module 110a, placing the rigidizing module 110a into the rigid configuration. In other examples, a permanent magnet may be linearly translated by the actuator from a first position to a second position, placing the rigidizing module 110a into the rigid configuration.

In some examples, the rigidizing module 110a comprises a gear train for resisting unwanted rotation of the permanent magnet. This may reduce likelihood that rigidizing module 110a transitions to a non-rigid configuration unless specifically directed into that configuration by the control system.

In another embodiment, the electrically controllable permanent magnet may be electrically actuated. The electrically controllable permanent magnet may comprise an electromagnet. By applying a current to the electromagnet in a direction, the electrically controllable permanent magnet may be enabled.

In some examples, any magnets present within rigidizing module 110a are of a composition that may resist demagnetization at high temperatures or levels of radiation, such as those the interface 100 may be exposed to if utilized in space exploration applications.

In an embodiment, rigidizing mechanism 110a may be a torque driven subsystem, such that torque passed to parent module 102 may be used to move the rigidizing mechanism 110a to a rigid configuration, or back. The torque passed to the parent module 102 may be received and transferred through the torque transfer mechanism 116a.

Auxiliary services module 120a provides for the transfer of auxiliary services from parent module 102 to child module 104. Auxiliary services module 120a may also provide for the transfer of at least some auxiliary services from the child module 104 to the parent module 102 in some embodiments. Auxiliary services may comprise electrical power transfer, data transfer, mechanical rotational energy transfer, fluid or pressurant transfer, or other auxiliary services.

Electrical power transfer module 112a is configured to engage a feature of child module 104, such that electrical power may be transferred from parent module 102 to child module 104.

In some embodiments, electrical power transfer module 112a may comprise a dust tolerant electrical contact. The electrical contact may be spring loaded to enable a reliable conductive connection. The electrical contact may be sealed such that environmental dust may not enter parent module 102.

In some embodiments, electrical power transfer module 112a may comprise an inductive coil. The inductive coil may inductively engage a component of child module 104, such that a voltage is induced in a component of child module 104, wirelessly transferring electrical power from parent module 102 to child module 104.

In some embodiments, electrical power transfer module 112a may comprise both a dust tolerant contact and an inductive coil.

Parent communication module 114a may engage a component of child module 104, such that parent communication module 114a may enable the transfer of data from parent module 102 to child module 104. In some embodiments, parent communication module 114a may be configured to receive data transferred from child module 104 to enable transfer of data from the child module 104 to the parent module 102.

Parent communication module 114a may comprise an RF data transmitter and receiver. In some embodiments, the RF data transmitter and receiver may communicate with other RF transmitters and receivers via an RF data link. In an example, the RF data transmitter and receiver may send and receive data at a rate of at least 3 Gbps, with a mating distance 118 of 1 mm, with regolith simulant present within the mating distance 118. In other embodiments, other frequencies, communication protocols, or other maximum data rates may be specified and used.

Torque transfer mechanism 116a is configured to transfer torque to the child module 104. The transferred torque can be used to operate a torque driven subsystem of the integrated payload/tool. The torque transfer mechanism 116a may comprise an internal motor and gearbox, which may rotate a dust tolerant mechanical interface. In some examples, the dust tolerant mechanical interface may comprise a fork arrangement, configured to encourage dust egress from the mechanical interface. In some examples, the dust tolerant mechanical interface may comprise a socket head configured to engage with a hex head feature on the child module 104. The dust tolerant mechanical interface of torque transfer module 116a may engage a feature of child module 104 to transfer rotational mechanical energy across interface 100. Child module 104 may receive the transferred rotational mechanical energy and pass the energy to a torque driven subsystem. A torque driven subsystem may be any component that may be driven by rotational motion.

In some examples, torque transfer mechanism 116a may comprise a magnetic inductance-based torque transfer mechanism. A magnetic inductance-based torque transfer mechanism may be particularly suitable in examples wherein the interface only requires low torque transfer. A magnetic inductance-based torque transfer mechanism may provide high speed, low torque transfer across the interface.

In some examples, the torque transfer mechanism 116a may be an active torque transfer mechanism which is configured to generate the torque that is transferred. In other examples, the torque transfer mechanism 116a may be a passive torque transfer mechanism which does not generate the torque transferred but rather receives torque across the interface 100 that has been generated by an external component (e.g. generated by a parent module 102 with an active torque transfer mechanism and through a child module 104 to a parent module 102 with a passive torque transfer mechanism).

The child module 104 includes a child mating surface 106b. In the interface 100 of FIGS. 1-2, the child mating surface 106b comprises a planar surface, which may be mated with, or butted against, or near another planar surface. In other embodiments, child mating surface 106b may comprise other shapes and configurations.

Child module 104 may be comprised of aluminum, or other high strength material or materials. Child module 104 is configured such that an external structure of the child module 104 is dust sealed, wherein dust present in the environment that child module 104 is being utilized may not enter the internal structure of child module 104. Components of child module 104 may be joined together with conformable seals. The conformable seals may ensure that no small gaps between components are present, reducing the risk of dust ingress. In some examples of child module 104, child module 104 may be configured such that parent module is at least IP6X dust tolerant.

Child module 104 further comprises a mechanical alignment target 108b, a rigidizing target 110b, and auxiliary services reception module 120b. The auxiliary services reception module 120b is configured to receive one or more auxiliary services from parent module 102. Auxiliary services reception module 120b comprises an electrical power reception module 112b, a child communication module 114b and a torque receiving mechanism 116b.

Mechanical alignment target 108b is configured to engage the mechanical alignment feature 108a present on parent module 102 when the interface 100 is in the mated configuration 100b. Mechanical alignment target 108a may comprise at least one dust tolerant aperture. In some example embodiments, mechanical alignment target 108b may comprise a plurality of dust tolerant apertures on the child module 104. Dust tolerant apertures are configured to receive mechanical alignment feature 108a of parent module 102. Mechanical alignment target 108b may be of a complementary shape or configuration to that of mechanical alignment feature 108a.

In some examples, the mechanical alignment target 108b may comprise a partial cone geometry, such as a half cone geometry. Such a configuration may provide for dust tolerance and/or dust egress. Dust tolerance and/or dust egress in such examples is facilitated by the conical surfaces of mechanical alignment target 108b, which are not complete cones. Such partial cone geometry prevents dust from becoming trapped and compressed within the alignment target 108b. In some embodiments, mechanical alignment targets 108b comprising substantially half cone geometry may be present. In other embodiments, alignment targets 108b comprising ⅓ cones or nearly full cones may be present, wherein an egress path is provided by not having a full conical receptacle as the alignment targets 108b.

Rigidizing target 110b is configured such that when interface 100 is in the mated configuration 100b, and rigidizing module 110a is activated or in a rigid configuration, the interface 100 is in a rigidized configuration. The parent module 102 and child module 104 cannot be separated in the axial direction 126 without the application of a significant external force. In some examples, this force may be a minimum of 50 N.

In some examples, rigidizing target 110b comprises a ferromagnetic body. Rigidizing target 110b is configured such that an electrically controlled magnet of rigidizing module 110a may magnetically engage with the ferromagnetic body, such that parent module 102 is generally fixed to child module 104 in the axial direction 126. In some examples, rigidizing target 110b may comprise a plurality of ferromagnetic bodies. Rigidizing target 110b may be composed of a combination of iron, nickel, cobalt, and/or any other ferromagnetic metal, alloy, or material.

Auxiliary services reception module 120b provides for the reception of auxiliary services from parent module 102 to child module 104, and vice-versa for at least some services in some embodiments. Auxiliary services may include electrical power transfer, data transfer, mechanical rotational energy transfer, fluid or pressurant transfer, or other auxiliary services.

Electrical power reception module 112b is configured to engage the electrical power transfer module 112a of parent module 102, such that electrical power may be transferred from the electrical power module 112a to the electrical power reception module 112b (to enable electrical power transfer from parent module 102 to child module 104).

In some embodiments, electrical power reception module 112b may comprise a dust tolerant electrical contact. The electrical contact may be a recessed, spring loaded electrically conductive cylinder. The cylinder may recess into child module 104. The interface separating the conductive cylinder from the child mating face 106b of child module 104 may be lined with a conformable seal, promoting dust tolerance. The electrical contacts of the electrical power reception module 112b may be configured to interface with electrical contacts of the electrical power transfer module 112a such that electrical power may be transferred from parent module 102 to child module 104 across the electrical contacts through conduction.

In some embodiments, electrical power reception module 112b may comprise an inductive coil. The inductive coil may inductively engage a component of parent module 102, such as an inductive coil of electrical power transfer module 112a, such that a voltage is induced in the electrical power reception module 112b, wirelessly transferring electrical power from parent module 102 to child module 104.

In some embodiments, the electrical power reception module 112a may include both a dust tolerance contact and an inductive coil.

The child communication module 114b may engage a component of parent module 102, such that the parent communication module 114a may enable the transfer of data from parent module 102 to child module 104. In some embodiments, the child communication module 114b may also be configured to transfer data from child module 104 to parent module 102.

The child communication module 114b may include an RF data transmitter and receiver. In some embodiments, the RF data transmitter and receiver may communicate with other RF transmitters and receivers (such as those that may be present in parent module 102) via an RF link. In an example, RF data transmitter and receiver may send and receive data at a rate of at least 3 Gbps, with a separation distance of 1 mm, with regolith simulant present between within the mating distance 118. In other embodiments, other frequencies, communication protocols, or other maximum data rates may be specified and used.

The torque receiving mechanism 116b is configured to receive torque transferred or applied to the torque receiving mechanism. The received torque may then be used to drive a torque driven subsystem or to pass the received torque through to another torque receiving mechanism. The torque receiving mechanism 116b includes an internal shaft, which may be rotated by a dust tolerant mechanical interface. In some examples, the dust tolerant mechanical interface may include a blade arrangement, configured to encourage dust egress from the mechanical interface. The dust tolerant mechanical interface may engage torque transfer mechanism 116a, wherein a blade feature of mechanism 116b may engage a fork feature of mechanism 116a to receive rotational mechanical energy transferred across interface 100. For example, a blade feature of mechanism 116b may be configured to engage a fork feature of mechanism 116a and, once engaged, the torque transfer mechanism 116a may rotate the blade feature of mechanism 116b to impart rotational mechanical energy to the engaged blade feature of mechanism 116b. In some cases, the received rotational mechanical energy may then be passed or transferred from the blade feature of mechanism 116b to a torque driven subsystem or to another torque receiving mechanism. In some examples, the dust tolerant mechanical interface may comprise a hex head configured to engage with a hex socket feature on parent module 102.

In some examples, torque receiving mechanism 116b may be referred to as the passive torque transfer mechanism.

In some examples, torque receiving mechanism 116b may be configured to receive torque through magnetic inductance. In such examples, no mechanically interacting components are required to transfer torque across the interface. This may be particularly advantageous in environments wherein mechanically interacting torque transfer mechanisms are unsuitable or less desirable (e.g. especially dusty environments), and wherein only a low level of torque is required to be transferred across the interface.

As described above, all components of interface 100 are configured to be dust tolerant, where relevant, including all sub-components of parent module 102 and child module 104. When interface 100 is in the mated configuration 100b, as pictured in FIG. 2, parent mating surface 106a and child mating surface 106b are substantially parallel. Additionally, parent module 102 and child module 104 may be separated by a mating distance 118 when in the mated configuration 100b. Mating distance 118 may be defined as a distance at which all sub-components of both the parent module 102 and child module 104 can engage one another.

In the mated configuration 100b, the parent module 102 may pass data and electrical power to the child module 104, and the child module 104 may pass data to parent module 102. When interface 100 is rigidized, the parent module 102 and the child module 104 are fixed together, such that they cannot be displaced relative to one another in the rotational or lateral direction 128, and can only be separated from one another in the axial direction 126 with the application of a force great enough to counter the force fixing rigidizing module 110a to rigidizing target 110b.

When the parent module 102 and the child module 104 are in the mated configuration 100b, as pictured in FIG. 2, the mechanical alignment feature 108a is engaged with mechanical alignment target 108b. In examples wherein the mechanical alignment feature 108a includes a protrusion, and the mechanical alignment target 108b includes an aperture configured to receive the mechanical alignment feature 108a, the mechanical alignment feature 108a may enter the aperture of the mechanical alignment target 108b, such that mechanical alignment feature 108a is engaged with mechanical alignment target 108b. When the mechanical alignment feature 108a is engaged with the mechanical alignment target 108b, the parent module 102 and the child module 104 may only be moved axially 126 away from one another. Movements in the rotational and or lateral direction 128 are limited. Additionally, when mechanical alignment feature 108a is engaged with mechanical alignment target 108b (e.g. in the mated configuration), parent module 102 and child module 104 are aligned, such that components of parent module 102 and child module 104 may subsequently engage one another. For example, electrical power transfer module 112a and electrical power reception module 112b may engage one another. In this way, engagement of the mechanical alignment feature 106a with the mechanical alignment target 106b promotes alignment of the parent module 102 to the child module 104 such that other components of the parent and child modules 102, 104 can subsequently engage one another.

Mechanical alignment feature 108a and mechanical alignment target 108b may be configured to allow both dust accommodation and egress. In examples comprising male pin-based coarse alignment feature, the mechanical alignment feature 108a provides a low surface area of contact, minimizing insertion loads. Mechanical alignment feature 108a and mechanical alignment target 108b are configured to handle shear, torsion, and bending loads, even in the case of dust buildup between components.

When interface 100 is in the mated configuration 100b, the rigidizing module 110a may engage rigidizing target 110b. When rigidizing module 110a and rigidizing target 110b are engaged, the parent module 102 cannot be readily separated from child module 104, and the interface 100 is in the rigidized configuration. Rigidizing module 110a generally fixes parent module 102 to child module 104 through rigidizing target 110b in the axial direction 126. When interface 100 is in the rigidized configuration, both rigidizing module 110a and rigidizing target 110b are engaged, and mechanical alignment feature 108a and mechanical alignment target 108b are engaged, the parent module 102 and child module are fixed to one another in the rotational and or lateral direction 128 and axial direction 126, such that they cannot be readily separated.

When interface 100 is in the mated configuration 100b (whether rigidized or not), electrical power transfer module 112a may engage electrical power reception module 112b. In examples wherein electrical power transfer module 112a and electrical power reception module 112b comprise inductive coils, which may be inductively coupled when the interface 100 is within the mating distance 118, the parent module 102 may pass electrical power to child module 104. In some examples, parent module 102 may pass electrical power to child module 104 at a rate of at least 70 W continuously, and 200 W at peak. In some examples, the interface 100 may comprise dynamic wireless power transfer, in which both electrical power transfer module 112a and electrical power reception module 112b include dynamic tuning. The use of dynamic tuning in inductive couplings may provide the ability to transfer high outputs of power with high efficiency through a layer of dust, including electrically conductive dust. Additionally, in examples of interface 100 in which electrical power transfer module 112a and electrical power reception module 112b do not comprise any conductively engaging components may advantageously improve reliability, as risks of physical connector jamming and/or imprecise alignment are reduced.

When interface 100 is in the mated configuration 100b (whether rigidized or not), child communication module 114b may engage parent communication module 114a, and vice versa. The parent module 102 and child module 104 may be separated by a distance 118, wherein the distance 118 is sufficiently small such that parent communication module 114a and child communication module 114b can transfer data between child module 104 and parent module 102 through a RF link, and or vice versa (i.e. the distance 118 is within an operative data transfer range of the communication modules 114a, 114b). Child communication module 114b may engage parent communication module 114a through any RF communication protocol known in the art for transferring data over an RF link.

Examples of interface 100 in which parent communication module 114a and child communication module 114b do not comprise any conductively engaging components may provide greater reliability, as risks of physical connector jamming and or imprecise alignment are reduced.

When interface 100 is in the mated configuration 100b, torque transfer mechanism 116a may transfer mechanical rotational energy to torque receiving mechanism 116b. In examples in which interface 100 comprises fork and blade features for torque transfer, the fork and blade features may provide high clearance and backlash built into the design, allowing interfering dust to move freely between the features. Additionally, dust egress pathways may be present, to minimize risk of buildup. Torque transfer components may be the only dynamic physically interacting components of interface 100. In examples wherein torque transfer mechanism 116a and torque receiving mechanism 116b transfer torque through magnetic induction, no mechanically interacting components are required, reducing dust interference and clearance issues.

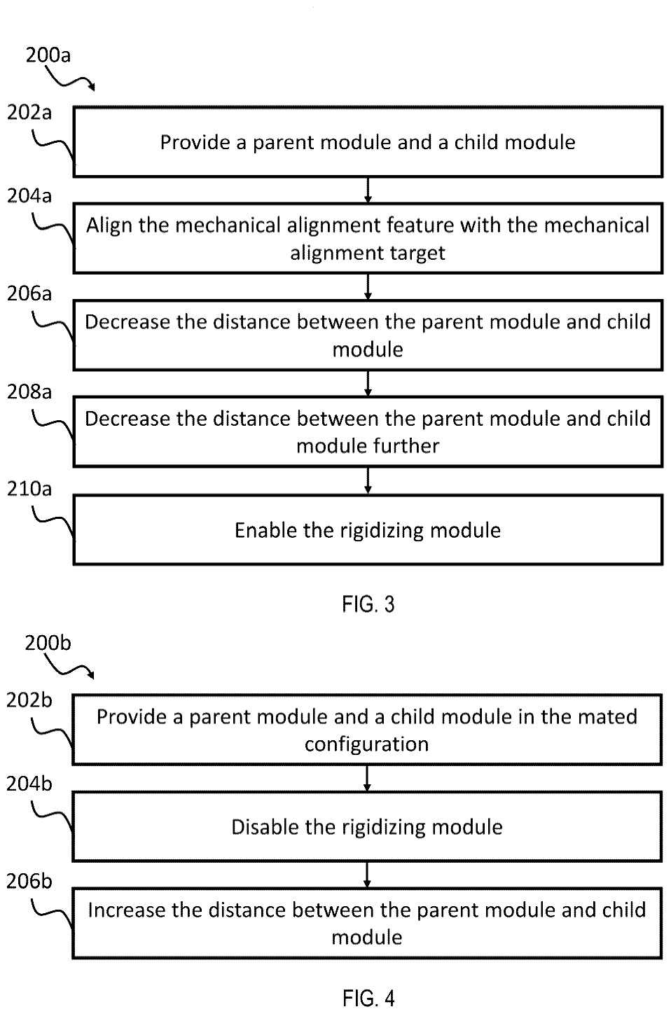

Referring now to FIG. 3, shown therein is a flowchart depicting a method 200 of mating the interface 100 of FIGS. 1-2, according to an embodiment. Description above in reference to FIGS. 1-2 above may apply to the method 200 of FIG. 3.

Method 200a comprises steps 202a, 204a, 206a, 208a, and 210a. Method 200a begins with step 202a.

At 202a, a parent module 102 and a child module 104 are provided. The parent module 102 and child module 104 may be provided in the unmated configuration 100a, such that each respective mating surface (106a, 106b) is separated from one another by distance greater than mating distance 118. In some cases, the position of the child module 104 may be fixed at 202a and the parent module 102 may be moved towards the child module 104 to bring the respective mating surfaces 106a, 106b closer together. This may include manipulating the parent module 102 such that the mating surface 106a of the parent module 102 faces the mating surface 106b of the child module 104.

At 204a, the mechanical alignment feature 108a of parent module 102 is aligned with the mechanical alignment target 108b of child module 104, such that the interface 100 is in an aligned state after the completion of 204a.

In some examples of method 200a, aligning may include fixing the position of child module 104, or a configuration in which child module 104 begins in a fixed position. Once the position of child module 104 is fixed, parent module 102 is manipulated in position until mechanical alignment feature 108a is aligned with mechanical alignment target 108b. In some examples, mechanical alignment feature 108a and mechanical alignment target 108b may comprise a central axis. When the central axis of each component is generally or near colinear, the mechanical alignment feature 108a and mechanical alignment target 108b may be deemed aligned. Mechanical alignment feature 108a and mechanical alignment target 108b may be separated by a distance greater than mating distance 118, and still be deemed aligned.

When mechanical alignment feature 108a is aligned with mechanical alignment target 108b, parent mating surface 108a and child mating surface 108b may be substantially parallel. When mechanical alignment feature 108a comprises at least three discrete features, mechanical alignment target 108b comprises at least three apertures configured to receive each discrete feature, and mechanical alignment features 108a are aligned with mechanical alignment target 108b apertures, parent mating face 106a and child mating face 106b are forced into a parallel position.

In other examples of step 204a, aligning may include fixing the position of parent module 102, or providing parent module 102 in a fixed position at step 202a. Once the position of parent module 102 is fixed, child module 104 is manipulated in position until mechanical alignment feature 108a is aligned with mechanical alignment target 108b.

In some examples of step 204a, alignment may be assisted or encouraged through the operation of a visible light camera present on parent module 102, and a camera target present on child module 104. The camera may comprise a deployable lens cover to improve dust tolerance. The camera and target may facilitate autonomous alignment. The parent module 102 may be manipulated until a feedback program accessing a data feed generated by the camera confirms that parent module 102 and child module 104 are aligned. In other examples, the alignment of step 204a may be assisted by other sensor and receiver pairs, including but not limited to ultrasonic, infrared, radar or any other sensor pair known in the art that may assist in precisely aligning two mechanical components. In other examples, positions of camera and target may be reversed. In other examples, alignment may be assisted with a camera or other sensor alone, without the assistance of another component, such as a target. In some examples, camera or sensor may be further equipped with a light, or IR light source.

In some examples of step 204a, alignment may be assisted or encouraged through the operation of a force-moment accommodation system, which may comprise force and or moment sensors embedded into mechanical alignment features 108a, or coupled to mechanical alignment features. Such sensors may detect when mechanical alignment features 108a are subjected to forces or moments in certain directions, or excessive forces or moments in any direction. In such examples, force and or moment sensors may provide feedback to other components of interface 100, for example, an automated control system, such that parent module 102 and child module 104 may execute step 204a while minimizing forces and moments on mechanical alignment features 108a (e.g. by precisely controlling position of parent module 102 and or child module 104 during step 204a). Such a force-moment accommodation system may provide more robust feedback than a camera-based alignment assistance system, as camera lenses may be blocked by dust or debris. In other examples, force and or moment sensors may be placed within other positions of interface 100.

In some examples of interface 100, mechanical alignment feature 108a comprises a plurality of alignment pins, and mechanical alignment target 108b comprises a plurality of apertures each configured to receive a respective one of the plurality of alignment pins of the mechanical alignment feature 108a. In such examples, when mechanical alignment feature 108a is aligned with mechanical alignment target 108b, parent mating surface 106a and child mating surface 106b may be substantially parallel.

At 206a, the distance between parent module 102 and child module 104 is decreased, until mechanical alignment feature 108a engages mechanical alignment target 108b. When mechanical alignment feature 108a is aligned with mechanical alignment target 108b, parent mating surface 106a and child mating surface 106b may be substantially parallel. As parent module 102 and child module 104 are brought closer together, the distance decreases between parent mating surface 106a and child mating surface 106b. Once the distance between parent module 102 and child module 104 is sufficiently small, mechanical alignment feature 108a may begin to engage with mechanical alignment target 108b.

As described above, mechanical alignment feature 108a may comprise at least one dust tolerant alignment pin. In some embodiments, the dust tolerant alignment pin may comprise a fine alignment feature and a coarse alignment feature. Mechanical alignment target 108b may comprise an aperture. At step 208a, the coarse alignment feature enters the aperture of the alignment target, such that rotational and or lateral 128 motion of parent module 102 relative to child module 104 is substantially limited by mechanical interference of the coarse alignment feature and the aperture of mechanical alignment target 108b.

At 208a, the distance between parent module 102 and child module 104 is decreased further. The distance 118 may be decreased until the distance is sufficiently small to enable the components of parent module 102 to engage partner components of child module 104. For example, rigidizing module 110a may engage rigidizing target 110b. At this distance, the interface 100 may be deemed to be in a mated configuration.

In some examples of step 208a wherein mechanical alignment feature comprises a fine alignment feature, the geometry of the fine alignment feature may engage the mechanical alignment target 108b, such that the parent module 102 is biased into a precisely aligned position relative to child module 104.

At 210a, the rigidizing module 110a is enabled. Rigidizing module 110a may engage rigidizing target 110b, such that parent module 102 and child module 104 are forced together in the axial direction 126. In examples wherein rigidizing module 110a comprises an electrically controllable magnet, and rigidizing target 110b comprises a ferromagnetic body, rigidizing module 110a is enabled by activating the electrically controllable permanent magnet, placing the rigidizing module 110a in the rigid configuration. As at 208a, parent module 102 and child module 104 are brought together at a distance such that rigidizing module 110a may engage rigidizing target 110b, when activated, and rigidizing module 110a creates a magnetic force that urges parent module 102 and child module 104 together in the axial direction 126.

After the completion of step 210a, parent module 102 and child module 104 are mated and rigidized. The interface 100 is mechanically rigid and may pass data and electrical power from parent module 102 to child module 104. Parent module 102 and child module 104 are separated by a distance 118 small enough such that all subcomponents of each module may engage corresponding components on the other module. In some examples, distance 118 may be at most 100 mm. Activating rigidizing module 110a provides attraction force in the axial direction 126, fixing parent module 102 and child module 104 together axially along direction 126, placing interface 100 into the rigidized configuration. Mechanical alignment feature 108a, by engaging mechanical alignment target 108b, fixes parent module 102 to child module 104 in the rotational and or lateral direction 128.

As previously described, interface 100 is configured to optimize dust tolerance. Physically engaging components may be limited to those necessary for functionality. Interface 100 may mate in dusty conditions, such as those in which dust may be trapped between parent module 102 and child module 104. Even in dusty conditions, the interface 100 may pass electrical power and data between child module 104 and parent module 102, and remain physically attached, when in the rigidized configuration. In some use cases, dust present within mated and/or rigidized interface 100 may be highly electrically and or thermally conductive. Subcomponents of Interface 100 are configured to tolerate highly electrically and or thermally conductive dust within distance 118 between parent module 102 and child module 104 when interface 100 is mated, as described previously, by reducing the number of physically engaging and moving mechanism components, and configuring electrical and RF features to be dust tolerant.

Referring now to FIG. 4, shown therein is a flow chart depicting a method 200b of un-mating the interface 100 of FIGS. 1-2, according to an embodiment. Description above in reference to method 200a may apply to method 200b.

Method 200b begins with step 202b, wherein a parent module 102 and a child module 104 are provided in the mated configuration 100b, and the interface 100 is rigidized. The mated configuration 100b after rigidization may comprise the condition of interface 100 after the completion of method 200a described above.

At 204b, rigidizing module 110a of parent module 102 is disabled, placing the rigidizing module 110a into the non-rigidized, mated, configuration. This may include, as previously described, actuating a magnet of the rigidizing module 110a from a second position (activate, rigidized position) to a first position (inactive, non-rigidized position). Once rigidizing module 110a is disabled, parent module 102 may be axially separated from child module 104.

At 206b, distance 118 between parent module 102 and child module 104 is increased, such that mechanical alignment feature 108a and mechanical alignment target 108b are disengaged from one another. This may comprise an unmated configuration. In some examples of interface 100, a camera or other sensor may be utilized to determine whether the distance between parent module 102 and child module 104 is great enough such that parent module 102 and child module 104 may be deemed unmated. Distance 118 may be sufficiently large when force or displacement is applied to interface 100 in the rotational or lateral direction 128, mechanical alignment feature 108a and mechanical alignment target 108b may not engage one another or interfere in the rotational or lateral direction 128.

After the completion of step 206b, interface 100 is now in unmated configuration 100a. Parent module 102 and child module 104 may now be mated and/or rigidized to other compatible components, such as other child modules and parent modules, respectively.

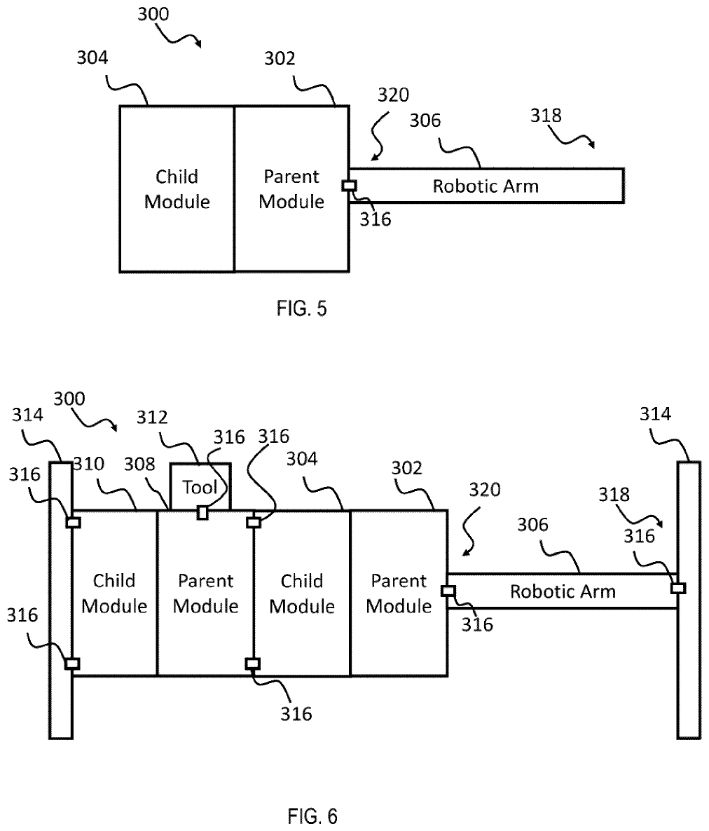

Referring now to FIG. 5, shown therein is a block diagram of a dust tolerant robotic system 300, according to an embodiment. The system 300 of FIG. 5 comprises a parent module 302, a child module 304, and a robotic arm 306. Parent module 302 may be analogous to parent module 102, and child module 304 may be analogous to child module 104, as described above in reference to FIGS. 1-2 and method 200. As pictured in FIG. 5, system 300 is in a mated configuration, as described above at 100b, and is rigidized.

In system 300, robotic arm 306 is connected to parent module 302 at a distal end 320 of robotic arm 306. A proximal end 318 of robotic arm 306 may be fixed, semi-fixed or otherwise attached to a robotic vehicle or other robotic system component. In some examples, parent module 302 may be removable from robotic arm through the removal of mechanical fasteners 316, such as machine screws, clips, bolts or other mechanical fasteners. The parent module 302 includes a robotic arm interface (not shown) for enabling mechanical and electrical connection of the parent module 302 to the robotic arm 306.

Parent module 302 may be an end effector of robotic arm 306. Not pictured in FIG. 5, child module 304 may comprise a grappling fixture, and may be connected to a tool (or parent module having a tool connected thereto), such that when parent module 302 mates and rigidizes to child module 304 the robotic arm 306 can manipulate the tool in space, and pass electrical power, data or torque to the tool via the interface.

In other examples, child module 304 may be fixed to other components for grappling and manipulation by robotic arm 306. These components may include batteries, pumps, tanks, control moment gyroscopes, current switching units, containers, logistic carriers, robotic components for repair, radiators, plasma dischargers, antennas, power conditioners and or fluid couplers. Such components may be connected or attached to a parent module 302 to which the child module 304 is mounted.

Robotic arm 306 may comprise any robotic arm known in the art. Robotic arm 306 must comprise sufficient rigidity to support parent module 302, and sufficient actuation force to manipulate the position of parent module 302. Robotic arm 306 may comprise any numbers of degrees of freedom and may comprise various sizes. A certain number of minimum degrees of freedom may be required to manipulate parent module 302, such that parent module 302 may mate to child module 304.

The robotic arm 306 may connect to a robotic arm controller for receiving arm movement commands from the robotic arm controller to control manipulation of the robotic arm 306 (and the connected parent module 302).

While not pictured in FIG. 5, robotic arm 306 may pass electrical power and data from robotic vehicle to parent module 302. In some examples, wherein robotic arm 306 is fixed to a robotic vehicle, the vehicle may pass data and electrical power through robotic arm 306, into parent module 302.

System 300 as pictured in FIG. 5 comprises a child module 304 mated to a parent module 302, wherein the interface between child module 304 and parent module 302 is rigidized. As described above, the interface composed of parent module 302 and child module 304 is dust tolerant and may pass electrical power and torque from parent module 302 to child module 304 and data between child module 304 and parent module 302.

Referring now to FIG. 6, shown therein is system 300 of FIG. 5, with additional components, according to an embodiment. Description above in reference to FIG. 5 also applies to the system of FIG. 6. The system 300 additionally comprises a second parent module 308, a second child module 310, a tool 312 and a vehicle 314. Second child module 310 may be fixed to vehicle 314 (as depicted by fastener 316). As described above in reference to FIG. 5, proximal end 318 of robotic arm 306 may be fixed to vehicle 314. Child module 304 is fixed to parent module 308, such that mating surfaces of each component are opposed from each other, and each module may mate to other parent and child modules, respectively. Child module 304 and parent module 302 may form a generally cohesive single unit and may pass electrical power, data, and mechanical torque between one another.

In the example of FIG. 6, tool 312 is fixed to second parent module 308, such that system 300 may comprise child module 304, parent module 308 and tool 312 forming single cohesive rigid unit when mated and rigidized. In other examples, tool 312 may be fixed to child module 304, or both second parent module 308 and child module 304.

Tool 312 may comprise a soil sample collector, or any other tool known in the art. Tool 312 may receive power and data through parent module 308, such that vehicle 314 may pass electrical power and communications to tool 312, such that vehicle 314 may control the operation of tool 312.

Parent module 302 may be mated and rigidized to child module 304, as described above in method 200. Second parent module 308 may be mated and rigidized to second child module 310.

In some examples of system 300, parent module 302 and child module 304 comprise torque transfer mechanism 116a and torque receiving mechanism 116b respectively. In some examples, second parent module 308 and second child module 310 do not comprise torque transfer mechanism 116a and torque receiving mechanism 116b respectively.

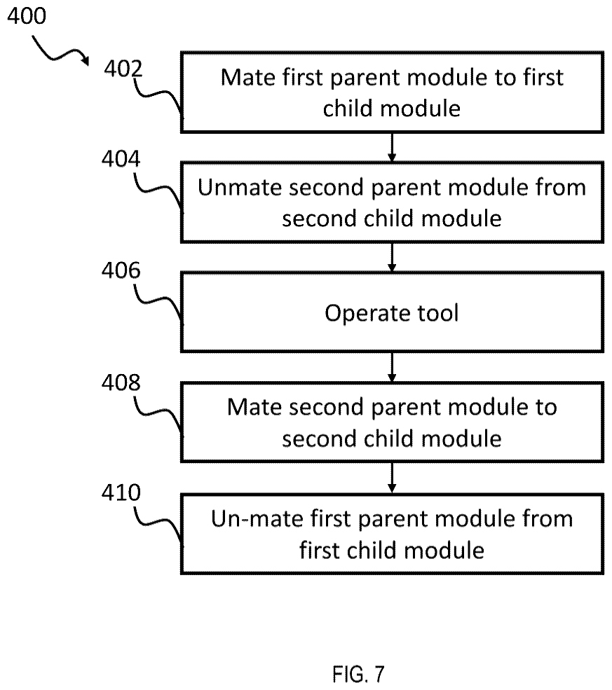

Referring now to FIG. 7, shown therein is a flow chart depicting a method 400 of operation of system 300 of FIG. 6, according to an embodiment. System 300 is provided with parent module 302 unmated from child module 304, and second parent module 308 mated and rigidized to second child module 310, such that tool 312 is stowed on vehicle 314 (indirectly through parent module 308 and child module 310), and robotic arm 306 is detached from tool 312. Child module 304 is fixed or mounted to second parent module 308. System 300 may be deployed in a dusty environment, for example, the lunar surface.

Method 400 begins with step 402. At 402, parent module 302 is mated with child module 304 and rigidized. Parent module 302 may be mated to child module 304 and rigidized, as described above in reference to method 200. After the modules 302, 304 are mated and rigidized to one another as described, robotic arm 306 is physically connected to tool 312 through child module 304.

At 404, second parent module 308 is unmated from second child module 310. Once the modules 308, 310 are unmated, tool 312 is attached to vehicle 314 through parent module 302, child module 304, parent module 308 and robotic arm 306, and detached from child module 310, such that robotic arm 306 may manipulate and operate tool 312.

At 406, tool 312 is operated. The vehicle 314 may adjust its position in space and operate tool 312 as desired, and or operate tool 312 by passing any one or more of torque, data, and electrical power to tool 312 through robotic arm 306, parent module 302 and child module 304. Tool 312 may additionally pass data back to vehicle 314 through child module 304, parent module 302 and robotic arm 306. Tool 312 may for example, be used to collect soil samples.

In some examples, tool 312 may be operated by a tool operating subsystem present in second parent module 308. Tool operating subsystem may receive electrical power, data and or torque from second parent module 308, and pass electrical power, data and or torque to tool 312 to operate tool.

At 408, second parent module 308 is mated to second child module 310 and rigidized, to store tool 312 on vehicle 314. This mating and rigidizing process may proceed as described above in reference to method 200. Once second parent module 308 is mated to second child module 310 and rigidized, tool 312 is reattached to vehicle 314 (indirectly through its attachment to second parent module 308).

At 410, parent module 302 is unmated from child module 304. After the completion of step 410, tool 312 is stored on vehicle 314, detached from robotic arm 306. Robotic arm 306 may be utilized for any other purpose, while tool 312 is safely stowed on vehicle 314.

While the above example describes that second child module 310 is fixed to the vehicle 314, in other examples, second module 310 may be fixed to another vehicle, spacecraft, or a fixed or dynamic physical structure, such that tool 312 may be stored on an object other than on the vehicle 314 comprising robotic arm 306.

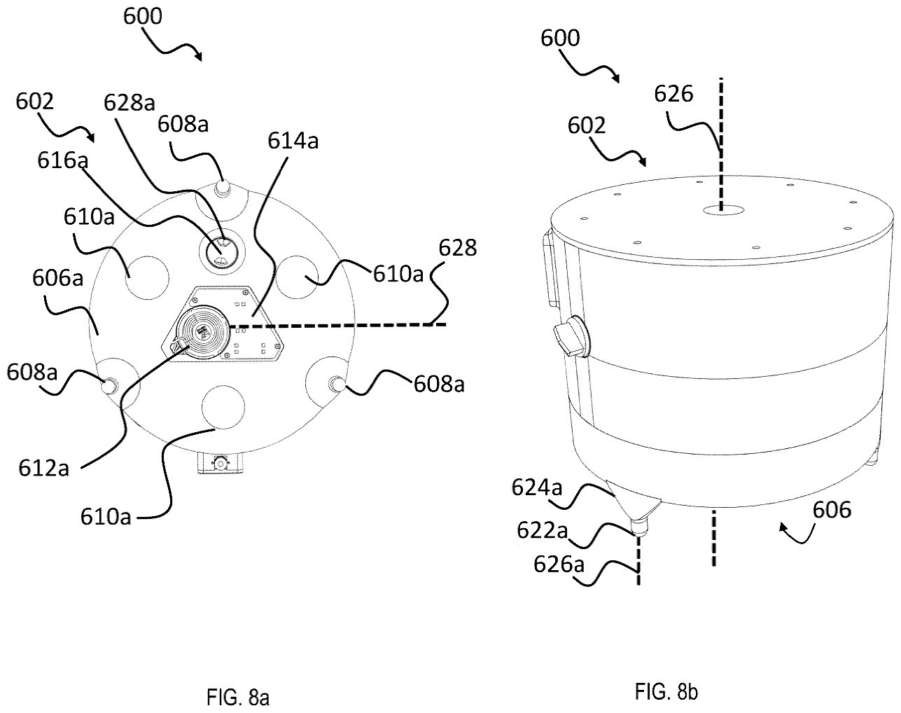

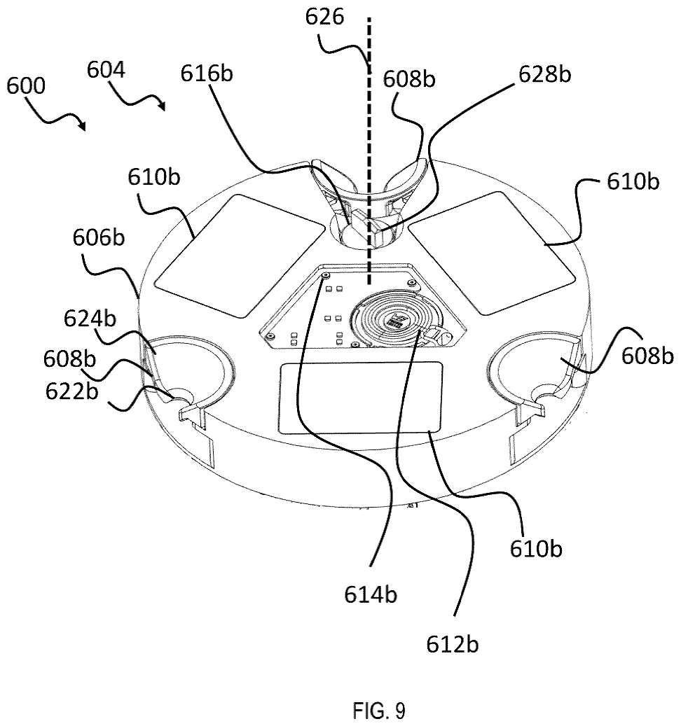

Referring now to FIGS. 8A, 8B, and 9, pictured therein is an example embodiment of an interface 600, according to an embodiment. Description above in reference to FIGS. 1-2 may apply to interface 600. Components of interface 100 may be analogous to components of interface 600, with reference characters each incremented by intervals of 500. Interface 600 comprises parent module 602 (FIG. 8A), and child module 604 (FIG. 9).

Referring to FIGS. 8A, and 8B, pictured therein is a bottom and top perspective view respectively of parent module 602, according to an embodiment. Parent module 602 is approximately cylindrical in shape. Parent module 602 may be composed of machined aluminum. Parent module 602 is configured such that dust ingress is minimized. Components of parent module 602 may be assembled with conformable seals, such as to promote dust resistance.

Parent module 602 comprises parent mating surface 606a. Parent mating surface 606a is a substantially planar surface of parent modules 602 generally cylindrical form.

Parent module 602 comprises three mechanical alignment features 608a. Each mechanical alignment feature 608a comprises a coarse alignment feature 622a, and a fine alignment feature 624a. Fine alignment feature 624a comprises a substantially conical protrusion, having a central axis 626a. Coarse alignment feature 622a comprises a substantially cylindrical extension out of the point of the conical form of fine alignment feature 624a, such that both fine alignment feature 624a and coarse alignment feature 622a share a common central axis 626a.

Parent module 602 comprises three rigidizing modules 610a. Each rigidizing module 610a comprises an electrically controllable permanent magnet. Each rigidizing module 610a may be activated by an actuator rotating a permanent magnet internal to rigidizing module 180 degrees, such that the electrically controllable permanent magnet is activated, and generating a magnetic field which may attract ferromagnetic materials. Each electrically controllable permanent magnet may be driven by an actuator, such as an internal motor, or a common motor for all rigidizing modules. In other embodiments of parent module 602, the actuator may be a passively driven actuator where the drive is supplied from an external component (e.g. motor, end effector) to the actuator. Each rigidizing module 610a comprises a gear train and or non-backdrivable screw drive which resists unwanted rotation of the permanent magnet, to prevent unwanted de-rigidization.

By generating attraction force between parent module 602 and child module 604 using electrically controllable permanent magnets, dust tolerance is maximized, as fewer physically interacting mechanical components, which are susceptible to dust related failure or interference, are exposed to the external environment.

Parent module 602 comprises electrical power transfer module 612a. Electrical power transfer module 612a comprises an inductive coil, which may engage another inductive coil, to wireless transfer electrical power from parent module 602 to another component. The inductive coil is configured such that parent module 602 may transfer electrical power at a rate of at least at least 70 W continuously, and 200 W at peak to another component.

Parent module 602 comprises parent communication module 614a. Parent communication module 614a comprises an RF data transmission and reception module, configured such that it may transmit and receive data at a rate of at least 3 Gbps. Parent communication module 614a may send and receive data using any RF communication protocol known in the art.

By transmitting data across interface 600 wirelessly, using RF communication instead of a conductive data link, dust tolerance of interface 600 is maximized.

Parent module 602 comprises torque transfer mechanism 616a. Torque transfer mechanism 616a comprises an internal motor and gearbox, which may rotate a dust tolerant mechanical interface 628a. The dust tolerant mechanical interface 628a comprises a fork arrangement, configured to encourage dust egress from mechanical interface 628a. Dust tolerant mechanical interface 628a may engage a feature of child module 604 to transfer rotational mechanical energy across interface 600.

Parent module 602, with sub-components as described above is configured to maximize dust tolerance. The number of exposed mechanisms and contact points are minimized. The only externally exposed mechanical components are torque transfer mechanism 616a, and mechanical alignment feature 608a, both of which are configured to maximize dust tolerance, and may operate in dusty environments.

Parent module 602 may additionally comprise internal control, computing and communication components, which may control each sub-component of parent module 602, and may communicate with external components attached to parent module 602, such as a robotic vehicle or robotic arm. Computing and communication components may include an EE controller CCA, motor drive amplifier CCA, I/O CCA, power conditioning CCA, and control software.

Referring now to FIG. 9, pictured therein is a perspective view of child module 604, according to an embodiment. Child module 604 is approximately cylindrical in shape. Child module 604 may be composed of machined aluminum. Child module 604 is configured such that dust ingress is minimized. Components of child module 604 may be assembled with conformable seals, such as to promote dust resistance.

Child module 604 comprises child mating surface 606b. Child mating surface 606b is a substantially planar surface of child module's 604 generally cylindrical form.

Child module 604 comprises three mechanical alignment targets 608b. Each mechanical alignment target 608b comprises coarse alignment aperture 622b, and fine alignment aperture 624b. Fine alignment aperture 622b comprises a generally conical recess. Coarse alignment aperture 624b comprises an additional aperture at the point of the cone of fine alignment aperture 622b. The coarse alignment aperture 622b is configured to receive the coarse alignment feature 622a of parent module 602, and fine alignment aperture 624b is configured to receive fine alignment feature 624a of parent module 602. The mechanical alignment features (e.g. 608b, comprising 622b and 624b, and 608a comprising 622a and 624b) permit coarse alignment to mating. Additionally, mechanical alignment features (e.g. 608b, comprising 622b and 624b, and 608a comprising 622a and 624b) withstand interface loads when fully aligned (i.e., the load path goes through these features).

Child module 604 comprises three rigidizing targets 610b. Each rigidizing target comprises a body of ferromagnetic material, such as iron, cobalt, nickel or any other ferromagnetic material known in the art. Each rigidizing target 610b is generally shaped like a rectangular prism. Rigidizing targets 610b are positioned such that when child module 604 and parent module 602 are mated, each rigidizing module 610a may engage a rigidizing target 610b.

Child module 604 comprises an electrical power reception module 612b. Electrical power reception module 612b comprises an inductive coil, which may engage electrical power transfer module 612a, to wirelessly receive electrical power from parent module 602. The inductive coil is configured such that parent module 602 may transfer electrical power to electrical power reception module 612b at a rate of at least 70 W continuously, and 200 W at peak.

Child module 604 comprises child communication module 614b. Child communication module 614b comprises an RF data transmission and reception module, configured such that it may transmit and receive data at a rate of at least 3 Gbps. Child communication module 614b may send and receive data using any RF communication protocol known in the art.

Child module 604 comprises torque receiving mechanism 616b. Torque receiving mechanism 616b comprises an internal shaft, which may be rotated by a dust tolerant mechanical interface 628b. The dust tolerant mechanical interface 628b comprises a blade arrangement, configured to encourage dust egress from mechanical interface 628b. Dust tolerant mechanical interface 628a may engage mechanical interface 628b, wherein the blade feature of interface 628b may engage the fork feature of interface 628a to receive rotational mechanical energy transferred across interface 600.

Child module 604 may additionally comprise internal control, computing and communication components, which may control each sub-component of child module 604, and may communicate with external components attached to child module 604, such as a robotic vehicle or robotic arm. Computing and communication components may include an EE controller CCA, motor drive amplifier CCA, I/O CCA, power conditioning CCA, and control software.

Parent module 602 and child module 604 as described above in reference to interface 100 and method 200, mate and rigidize to form interface 600. Parent mating surface 606a and child mating surface 606b are arranged such that they are substantially parallel. Mechanical alignment features 608a engage mechanical alignment targets 608b, such that each mechanical alignment feature 608a is received by each mechanical alignment target 608b, aligning corresponding subcomponents of each module. When features 608a and targets 608b are mated, rotational and or lateral movement of child module 604 relative to parent module 602 is limited. Rigidizing modules 610a may be engaged, such that they are in a rigid configuration. Rigidizing modules 610a are attracted to rigidizing targets 610b, securing parent module 602 to child module 604 in the axial direction, placing the interface into a rigidized configuration. Electrical power transfer module 612a may inductively engage electrical power reception module 612b, such that electrical power may be wirelessly transferred from parent module 602 to child module 604. Parent communication module 614a and child communication module 614b may interact via RF communication to wirelessly transfer data bi-directionally between child module 604 and parent module 602. Torque transfer module 616a may engage torque receiving module 616b, such that rotational mechanical energy may be transferred from parent module 602 to child module 604.

Mated and rigidized interface 600 may form robotic interfaces to be utilized in dusty environments. Mechanical interfaces are limited to mechanical alignment features and features for transferring mechanical energy. All mechanical interfaces are designed to tolerate dust, including electrically conductive dust. The rigidizing system, utilizing magnetic attraction, provides a high level of dust tolerance, and provides sufficient attraction force for common robotics applications. Wireless data and electrical power transfer across the interface 600 eliminates the need for conductive electrical contacts, which may be susceptible to occlusion by dust, corrosion in harsh environments, or other issues in dusty environments. Wireless data and electrical power transfer as described above are configured to tolerate conductive dust between parent module 602 and child module 604.

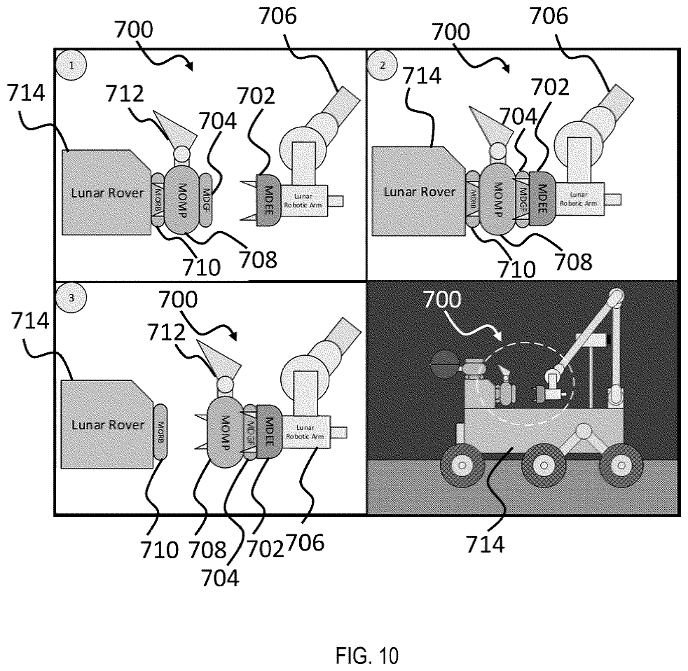

Referring now to FIG. 10, pictured therein is a robotic system 700 utilizing the components of interface 600, as well as an associated method 800 of operating robotic system 700. System 700 comprises Magnetic Dexterous End Effector (MDEE) 702, Magnetic Dexterous Grapple Fixture (MDGF) 704, Magnetic Orbital Replaceable Unit Mounting Platform (MOMP) 708, robotic arm 706, Magnetic Orbital Replaceable Unit Receptacle Base (MORB) 710, tool 712, and vehicle 714. MOMP 708 may have the same functionality as MDEE 702, with the exception of MOMP 708 implementing passive actuation of the magnetization/rigidization modules, through the reception of torque across the interface 600 (i.e. torque received by MOMP 708 across the interface is used to actuate the magnets). Components of system 700 are analogous to components of system 300, with each reference character incremented by 400.

MDEE 702 comprises a parent module 602, fixed to robotic arm 706. MDGF 704 comprises a child module 604. MOMP 708 comprises a parent module 602. MOMP 708 and MDGF 704 are fixed to one another, forming a single unified unit. MOMP 708 and MDGF 704 may pass data, electrical power, and rotational mechanical energy between one another. MOMP 708 and MDGF 704 are arranged such that mating surfaces 606a, 606b of each component are opposing one another, and may be mated to another component and rigidized. Tool 712 is fixed to MOMP 708 and may be controlled by passing data and electrical power to and from MOMP 708.

MORB 710 comprises a child module 604. MORB 710 is fixed to vehicle 714.

In some examples of system 700, MOMP 708 and MORB 710 may comprise embodiments of parent module 602 and child module 604 without torque transfer mechanism 616a and torque receiving mechanism 616b, respectively. Such configuration may be used, for example, where a torque interface is only necessary between MDEE 702 and MDGF 704.

Tool 712 may be any tool known in the art that may be advantageously manipulated by a robotic arm. Tool 712 may include any tool commonly used in space exploration operations. Tool 712 may comprise features that enable tool 712 to collect and store soil samples.

Vehicle 714 may be any vehicle known in the art, including a robotic lunar exploration vehicle, or other space exploration vehicle.

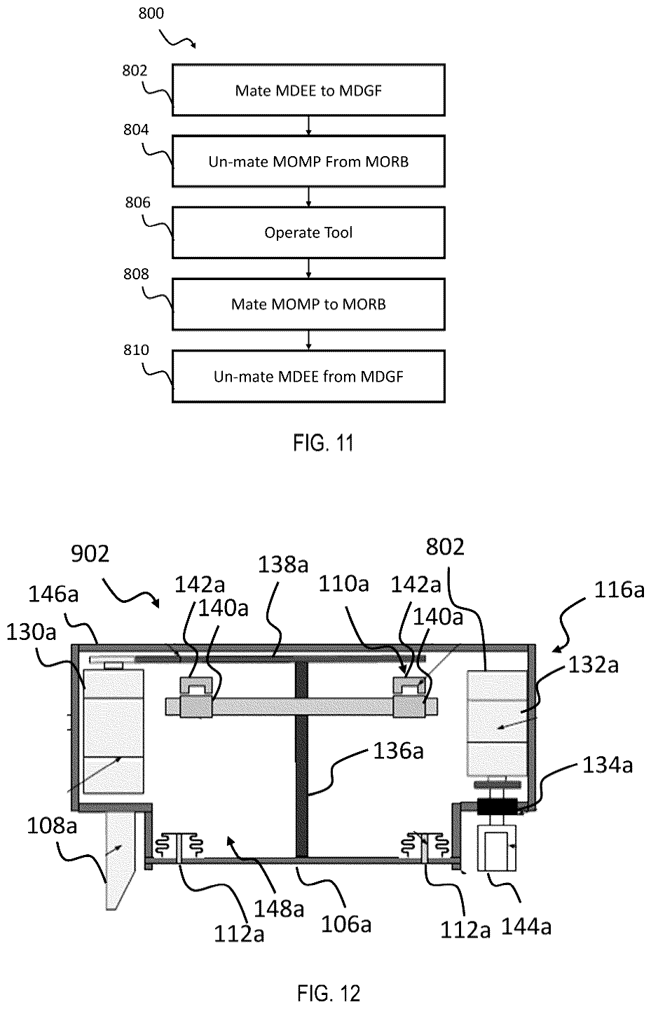

Referring now to method 800 of FIG. 11, described therein is a method of operating system 700. Description above in reference to method 300 applies to method 800. Method 800 begins with MDEE 702 unmated from MDGF 704, and MOMP 708 mated to MORB 710 and rigidized.

At step 802, robotic arm 706 is manipulated such that MDEE 702 may be mated to MDGF 704, and rigidized. Once mated and rigidized, robotic arm 706 is connected to tool 712 through MOMP 708, MDGF 704, and MDEE 702. At the end of step 802, tool 712 also remains attached to vehicle 714 indirectly through MOMP 708 and MORB 710.

At step 804, MOMP 708 is unmated from MORB 710. After the completion of step 804, tool 712 is connected to robotic arm 706 indirectly through MOMP 708, MDGF 704, and MDEE 702, and disconnected from vehicle 714, such that robotic arm 706 may manipulate and operate tool 712.

At step 806, tool 712 is operated. Robotic arm 706 may operate tool by manipulating position of tool 712. Robotic arm 706 may pass electrical power and data (e.g. control signals) to tool 712 through MDEE 702, MDGF 704 and MOMP 708.

When step 806 is completed, step 808 may be executed. At step 808, MOMP 708 is mated to MORB 710 and rigidized, such that tool 712 is securely coupled to vehicle 714. After the completion of step 808, tool 712 remains mated and rigidized to robotic arm 706 through MDEE 702, MDGF 704 and MOMP 708.

At step 810, MDEE 702 is unmated from MDGF 704. After the completion of step 810, tool 712 is stowed, fixed to vehicle 712, and robotic arm 706 is idle and free to mate and rigidize with other tools through the interface of MDEE 702, to conduct other operations.

Referring now to FIG. 12, pictured therein is a cross sectional view of a parent module 902 according to an embodiment. Parent module 902 is an example of parent module 102 of FIG. 1. In an embodiment, parent module 902 of FIG. 12 may be parent module 302 of FIG. 6.

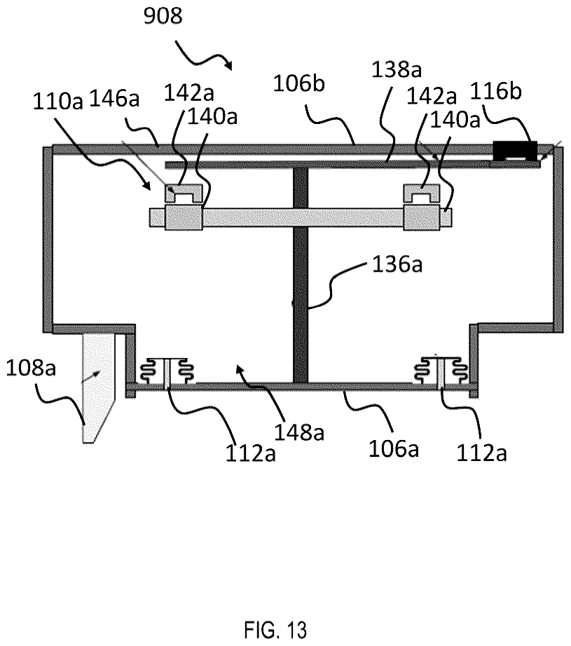

In an example, parent module 902 may be an end effector configured to mate and rigidize with a child module (not shown in FIG. 13) connected to parent module 908 of FIG. 13 such that the parent modules 902 and 908 are connected and the parent module 902 can manipulate the parent module 908, which may have a tool attached thereto. The connection of parent modules 902 and 908 through an intermediate component (child module), is exemplified in FIG. 6, wherein parent module 302 and second parent module 308 are connected through child module 304.

Parent module 902 comprises outer housing 146a. Outer housing 146a is generally cylindrical in shape. Outer housing 146a may be composed of aluminum. The outer envelope of outer housing 146a defines an interior volume 148a. Parent module 902 additionally comprises mating surface 106a. Parent module 902 may mate to a child module. During mating, mating surface 106a is substantially parallel to a mating surface of a child module and separated by a relatively small distance.

Rigidizing module 110a of parent module 902 includes an actuator, comprising rigidize drive 130a, a gear stage 138a, a drive screw 136a, permanent magnets 140a, and ferromagnetic material 142a. The rigidizing module of parent module 902 is actively actuated. To actuate rigidizing module 110a, rigidize drive 130a is supplied a current, rotating gear stage 138a, which rotates drive screw 136a, such that permanent magnets 140a may translate downwards along drive screw 136a, towards mating surface 106a. When a child module is placed in a position such that it may mate with parent module 902, permanent magnets may attract a rigidizing target (such as a ferromagnetic material) present within the child module, fixing the child module to parent module 902, placing the interface into a rigidized configuration.

Parent module 902 comprises torque transfer module 116a. Torque transfer module 116a includes a torque drive 132a and a compliant socket 144a. Torque drive 132a may be supplied a current, such that torque drive 132a may rotate a shaft connected to compliant socket 144a. Compliant socket 144a may rotate, and interface with a component of a child module, such that torque is transferred across the interface. Torque transfer module 116a additionally comprises conformable seal 134a, sealing the interior volume 148a from the exterior, to promote dust tolerance.

Parent module 902 further comprises mechanical alignment feature 108a. Only a single mechanical alignment feature 108a is visible in FIG. 12, however, in the embodiment of FIG. 12, a plurality of identical features are present. Parent module 902 further comprise electrical power transfer mechanism 112a. Electrical power transfer mechanism 112a comprises four radial socket (e.g., RADSOK™) pins (2 radial socket pins not pictured in FIG. 12), which may interface with corresponding radial socket pins on a child module. Parent module 902 further comprises a parent communication module, which is not visible in FIG. 12.

Referring now to FIG. 13, pictured therein is a cross sectional view of parent module 908, according to another embodiment. Parent module 908 is an example of parent module 102 of FIG. 1. In an embodiment, parent module 908 of FIG. 13 may be parent module 308 of FIG. 6.

Not pictured in FIG. 13, parent module 908 may comprise or be connected to another tool or component. The associated tool may be operated by passing torque, data or electrical power through parent module 908 to the tool. Parent module 908 may additionally comprise a tool operating subsystem (not shown).

Parent module 908 comprises outer housing 146a. Outer housing 146a is generally cylindrical in shape. Outer housing 146a may be composed of aluminum. The outer envelope of outer housing 146a defines an interior volume 148a. Parent module 908 additionally comprises mating surface 106a. Parent module 908 may mate to a child module. During mating, mating surface 106a will be substantially parallel to a mating surface of a child module and separated by a relatively small distance.

Parent module 908 comprises torque receiving mechanism 116b. Torque receiving mechanism 116b comprises a compliant interface which may interface with an external component, such that the external component may impart torque onto the torque receiving mechanism 116b. The torque receiving mechanism 116b may then pass torque to a torque operated subsystem.

Parent module 908 comprises a rigidizing module 110a. The rigidizing module 110a of parent module 908 is passively actuated and may be described as a torque operated subsystem. Torque is externally supplied to rigidizing module 110a and is received through torque receiving mechanism 116b, rotating gear stage 138a, which rotates drive screw 136a, such that permanent magnets 140a may translate downwards along drive screw 136a, towards mating surface 106a. When a child module is placed in a position such that it may mate with parent module 908, for example near mating surface 106b, permanent magnets may attract a rigidizing target (such as a ferromagnetic material) present within the child module, fixing the child module to parent module 908, placing the interface into a rigidized configuration.

Parent module 908 further comprises mechanical alignment feature 108a. Only a single mechanical alignment feature 108a is visible in FIG. 13, however, in the embodiment of FIG. 13, a plurality of identical features are present. Parent module 908 further comprise electrical power transfer mechanism 112a. Electrical power transfer mechanism 112a comprises four radial socket pins (2 radial socket pins not pictured in FIG. 13), which may interface with corresponding radial socket pins on a child module. Parent module 908 further comprises a parent communication module, which is not visible in FIG. 13.

In some examples, parent module 902 may couple to parent module 908 through an intermediate component as described above. The intermediate component may be a child module attached or mounted to the parent module 908 at surface 106b. In such examples, parent module 902 may transfer electrical power, data and torque through the intermediate component, to parent module 908. Parent module 908 may utilize torque passed through the intermediate component from parent module 902 to operate passively actuated rigidizing module 110a, as described above. Parent module 908 may interface with an attached tool by passing data, torque or electrical power through to the tool, to operate the tool.

In some examples, parent module 902 may be an end effector of a robotic arm and may mate and rigidize to parent module 908 indirectly through an intermediate component (i.e. child module). In such examples, parent module 902 may transfer electrical power, data and torque through the intermediate component, to parent module 908. Parent module 908 may utilize torque passed through from parent module 902 via the intermediate component to operate passively actuated rigidizing module 110a, as described above. Parent module 908 may interface with an attached tool by passing data, torque or electrical power through to the tool, to operate the tool. The attached robotic arm may manipulate parent module 902 and parent module 908 in space to manipulate the position of the attached tool.

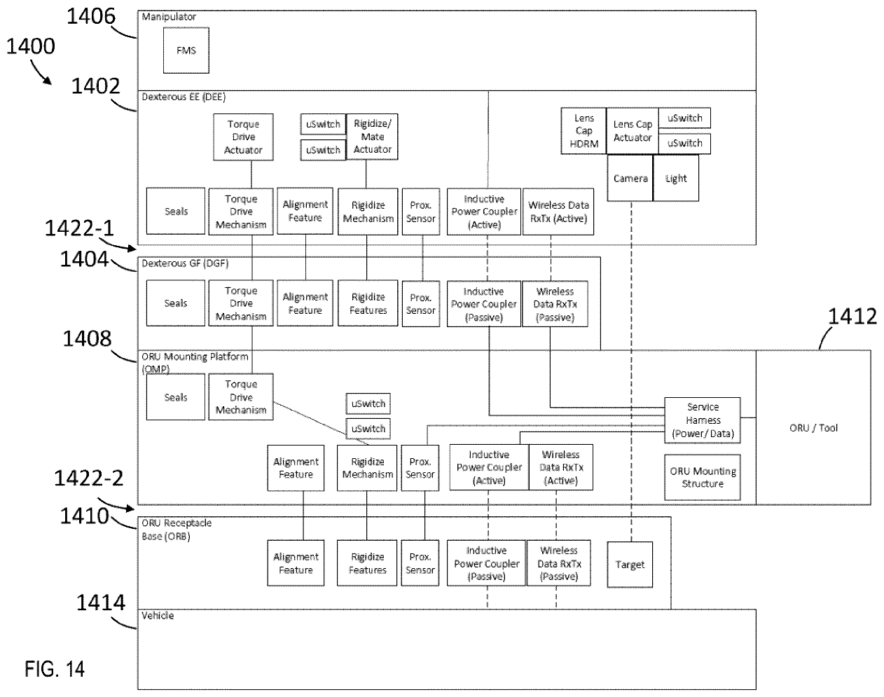

Referring now to FIG. 14, shown therein is a dust tolerant robotic system 1400, according to an embodiment. System 1400 is an example of the system of FIG. 6. The system 1400 comprises a vehicle 1414, first parent module (which is a Magnetic Dexterous End Effector in this example) 1402, first child module (which is a Dexterous grapple fixture (“GF”) in this example) 1404, second parent module (ORU Mounting Platform in this example) 1408, second child module (ORU Receptacle Base in this example) 1410, robotic arm (Manipulator in this example) 1406, and tool (ORU/Tool in this example) 1412. Components of system 1400 may be analogous to components of system 300 of FIG. 6, with the reference characters of each component incremented by 1100. Description above in reference to FIG. 6 may apply to system 1400. Parent module 1402 is depicted as mated to child module 1404 and rigidized, and parent module 1408 is depicted as mated to child module 1410 and rigidized in FIG. 14.

Parent module 1402 may be permanently or removably fixed to robotic arm 1406. Parent module 1402 may mate with child module 1404 and rigidize, wherein parent module 1402 and child module 1404 form a first robotic interface 1422-1 (shown in the mated and rigidized configuration).

Child module 1404 may be permanently or removably fixed to parent module 1408. In FIG. 14, child module 1404 is a grapple fixture component configured to enable parent module 1408, to which child module 1404 is fixed, to be grappled by the end effector parent module 1402 such that manipulator 1406 can manipulate the parent module 1408.

Parent module 1408 may mate and rigidize with child module 1410, wherein parent module 1408 and child module 1410 form a second robotic interface 1422-2 (shown in the mated and rigidized configuration). Child module 1410 may be permanently or removably fixed to vehicle 1414. Tool 1412 may be permanently or removably fixed to parent module 1408.

When the modules of system 1400 are in the mated and/or rigidized configuration, as depicted in FIG. 14, parent module 1402 may pass electrical power, data, and torque to child module 1404 across interface 1422-1. Child module 1404 may receive electrical power, data, and torque and, in turn, pass electrical power, data, and torque to parent module 1408. Parent module 1408 may pass electrical power and data to tool 1412 and child module 1410 across the second interface 1422-2.

System 1400 may be applied in a space exploration environment. Parent module 1402 may mate and rigidize to child module 1404, and parent module 1408 may unmate from child module 1410, such that robotic arm 1406 may manipulate and make use of tool 1412, passing data and electrical power to tool 1412.

Once the tool 1412 is no longer in use, the parent module 1408 may be mated to child module 1410 and rigidized, and parent module 1402 may be unmated from child module 1404, such that tool 1412 is disconnected from robotic arm 1406 and coupled to vehicle 1414 for storage.

While the above description provides examples of one or more apparatus, methods, or systems, it will be appreciated that other apparatus, methods, or systems may be within the scope of the claims as interpreted by one of skill in the art.

1. A dust tolerant electromechanical interface, the interface comprising:
a parent module comprising a parent mating surface, a mechanical alignment feature, a rigidizing module, and an auxiliary services module;
a child module comprising a child mating surface, a mechanical alignment target, a rigidizing target, and an auxiliary services reception module;
wherein the interface includes an unmated configuration and a mated and rigidized configuration;
wherein when the interface is in the mated and rigidized configuration:
the parent mating surface and child mating surface are substantially parallel and within a separation distance, the separation distance corresponding to a distance separating the parent mating surface and child mating surface within which the rigidizing module of the parent module is operative to fix the child module to the parent module;
the mechanical alignment feature engages the mechanical alignment target;
the rigidizing module engages the rigidizing target;
the auxiliary services module engages the auxiliary services reception module such that auxiliary services can be passed to the child module; and
the rigidizing module is enabled, fixing the parent module to the child module.

2. The interface of claim 1, wherein the auxiliary services module comprises an electrical power transfer module, and the auxiliary services reception module comprises an electrical power reception module.

3. The interface of claim 1, wherein the auxiliary services module comprises a parent communication module, and the auxiliary services reception module comprises a child communication module.

4. The interface of claim 1, wherein the rigidizing module comprises a controllable magnet, and the rigidizing target comprises a ferromagnetic body, wherein when the interface is in the mated and rigidized configuration, the controllable magnet is active, such that magnetic force fixes the parent module to the child module.

5. The interface of claim 2, wherein the electrical power transfer module and the electrical power reception module are inductively coupled, such that when the electrical power transfer module and the electrical power reception module are within a transferring distance, the electrical power transfer module induces a voltage within the electrical power reception module, transferring power from the electrical power transfer module to the electrical power reception module.

6. The interface of claim 5, wherein when the interface is in the mated and rigidized configuration, the electrical power transfer module and the electrical power reception module are within the transferring distance.

7. The interface of claim 5, wherein the electrical power transfer module transfers power to the electrical power reception module of at least 70 W continuously.

8. The interface of claim 6, wherein the electrical power transfer module and the electrical power reception module are conductively coupled, such that the electrical power transfer module conducts electrical power to the electrical power reception module.

9. The interface of claim 3, wherein the parent communication module comprises an RF transmitter and receiver, and the child communication module comprises an RF transmitter and receiver, wherein when the interface is in the mated and rigidized configuration, the parent communication module sends and receives an RF signal to and from the child communication module.

10. The interface of claim 9, wherein the RF signal transfers data at a rate of at least 3 Gbps.

11. The interface of claim 1, wherein the mechanical alignment feature comprises a plurality of dust tolerant alignment pins, and the mechanical alignment target comprises a plurality of dust tolerant apertures which are configured such that the dust tolerant apertures receives the dust tolerant alignment pins.

12. The interface of claim 1, wherein the auxiliary services module further comprises a torque transfer mechanism and the auxiliary services reception module further comprises a torque receiving mechanism, and wherein when the interface is in the mated and rigidized configuration, the torque transfer mechanism engages the torque receiving mechanism, such that the torque transfer mechanism rotates the torque receiving mechanism.

13. The interface of claim 1, wherein the rigidizing module comprises a controllable magnet, and the rigidizing target comprises a ferromagnetic body, wherein when the interface is in the mated and rigidized configuration, the controllable magnet is active, such that magnetic force fixes the parent module to the child module.

14. A method of mating and rigidizing the interface of claim 1, the method comprising:
providing a parent module and a child module, wherein the parent module and child module are in the unmated configuration;
aligning the mechanical alignment feature with the mechanical alignment target;
decreasing the distance between the parent module and child module, until the mechanical alignment feature engages mechanical alignment target;
decreasing the distance between the parent module and child module further, such that the mechanical alignment feature and mechanical alignment target bias the parent module and child module into a position such that child mating surface and parent mating surface are substantially parallel; and
enabling the rigidizing module, fixing the parent module to the child module.

15. A dust tolerant robotic system, comprising:
a static or mobile platform;
a robotic arm, having a proximal end and a distal end, wherein the robotic arm is coupled to the platform at its proximal end;
a first parent module of the electromechanical interface of claim 1, coupled to the distal end of the robotic arm; and
a first child module of the electromechanical interface of claim 1, wherein the child module is configured to be reversibly mated and rigidized with the parent module coupled to the distal end of the robotic arm, forming a first interface in the mated and rigidized configuration.

16. The robotic system of claim 15, further comprising:
a second parent module, wherein the second parent portion is fixed to the first child module; and
a tool, fixed to the first child module or the second parent module.

17. The robotic system of claim 16, further comprising:
a second child module fixed to a surface of the platform;
wherein the second parent module is configured to be reversibly mated and rigidized to the second child module, forming a second interface in the mated and rigidized configuration; and
wherein the first interface is configured to be in an unmated configuration while the second interface is in a mated and rigidized configuration, such that the tool is coupled to the platform through the second parent module or first child module, and not the robotic arm.

18. The robotic system of claim 15, wherein the auxiliary services module of the first parent module comprises a torque transfer mechanism and the auxiliary services module of the first child module further comprises a torque receiving mechanism, and wherein when the first interface is in the mated and rigidized configuration, the torque transfer mechanism engages with the torque receiving mechanism, such that the torque transfer mechanism rotates the torque receiving mechanism.

19. The robotic system of claim 18, wherein the torque receiving mechanism provides rotational force to the tool.

20. The robotic system of claim 18, wherein the torque transfer mechanism of the first parent module transfers torque through the torque receiving mechanism of the first child module to a torque transfer mechanism of the second parent module, and wherein the torque received at the torque transfer mechanism of the second parent module is used to actuate the rigidizing module of the second parent module.
